(19) United States
(12) Patent Application Publication
(10) Pub. No.: US 2024/0375488 A1
(43) Pub. Date: Nov. 14, 2024

(54) AIR-CONDITIONING REGISTER

(71) Applicant: TOYODA GOSEI CO., LTD., Kiyosu-shi (JP)

(72) Inventors: Daigo ARIKI, Kiyosu-shi (JP); Hiroto WATANABE, Kiyosu-shi (JP)

(21) Appl. No.: 18/640,436

(22) Filed: Apr. 19, 2024

(30) Foreign Application Priority Data
May 11, 2023 (JP) 2023-078781

(51) Int. Cl. B60H 1/34

(52) U.S. Cl. CPC B60H 1/3421; B60H 2001/3471

(57) ABSTRACT

An air-conditioning register includes a retainer defining a vent passage including an outlet, two fins disposed upstream of the outlet in the vent passage, and an actuation mechanism. The actuation mechanism is configured to move the fins between the neutral positions and the inclined positions. When the fins are in the neutral positions, the actuation mechanism causes the fins to extend in the inflow direction and face each other in a direction orthogonal to the inflow direction. When the fins are in the inclined positions, the actuation mechanism moves the fins to separate locations respectively located upstream and downstream from the neutral positions, and tilts the fins with respect to the inflow direction such that downstream sides of the fins are located inward in the vent passage.

### BACKGROUND

### 1. Field

The present disclosure relates to an air-conditioning register that uses fins to change the direction of air-conditioning air that is sent from an air conditioner and to be blown out from an outlet.

### 2. Description of Related Art

Air-conditioning registers are installed in vehicles to change the direction of air-conditioning air that is sent from an air conditioner and to be blown out from an outlet into the passenger compartment.

Japanese Laid-Open Patent Publication No. 2004-322981 and Japanese Laid-Open Patent Publication No. 2022-152633 describe examples of air-conditioning registers that include a retainer with a vent passage for air-conditioning air and two fins in the vent passage. The vent passage has an outlet at its downstream end in the flow direction of air-conditioning air. The fins are placed upstream of the outlet in the vent passage.

The flow direction, which is changed by the fins, includes an inflow direction, which is the flow direction of the air-conditioning air immediately before entering between the fins. The positions of the fins that cause the air-conditioning air to be blown out from the outlet in the inflow direction are referred to as neutral positions. The positions of the fins that cause the air-conditioning air to be blown out from the outlet in a direction inclined with respect to the inflow direction are referred to as inclined positions.

In the air-conditioning registers of the above publications (hereinafter referred to as conventional air-conditioning registers), each of the fins includes an inclined portion that is always inclined with respect to the inflow direction such that the downstream side is located inward in the vent passage.

The conventional air-conditioning register includes an actuation mechanism to move the fins between the neutral positions and the inclined positions.

The actuation mechanism causes the inclined portions in the neutral positions to face each other in a direction orthogonal to the inflow direction. In this state, the air-conditioning air flowing near the fins flows along the inclined portions of the fins, thereby changing its flow direction to the inner side in the vent passage. The inclined portions are inclined in opposite directions such that the downstream sides in the inflow direction of the inclined portions form a narrower space in between. As such, the air-conditioning air flows between the inclined portions while converging in the central area between the fins.

One of the inclined portions is at a location shifted upstream from the neutral position and inclined with respect to the inflow direction such that the downstream side is located inward in the vent passage. In the inclined positions, the other fin is at a location shifted downstream from the neutral position and inclined with respect to the inflow direction such that the downstream side is located inward in the vent passage.

As described above, the air-conditioning air flowing near the downstream fin flows along the inclined portion of the fin, thereby changing its flow direction to the inner side of the vent passage. Also, the air-conditioning air flowing near the upstream fin flows along the inclined portion of the fin, thereby changing its flow direction to the inner side of the vent passage. This air-conditioning air impinges on the inclined portion of the downstream fin and flows along this inclined portion, thereby changing its flow direction.

Accordingly, the amount of air-conditioning air blown out from the outlet after flowing along the inclined portion of the downstream fin is increased by the air-conditioning air whose flow direction has been changed by the inclined portion of the upstream fin.

However, in the above-mentioned conventional air-conditioning register, the inclined portions of the fins are always inclined with respect to the inflow direction such that the downstream sides are located inward in the vent passage not only in the inclined positions but also in the neutral positions. In the neutral positions, the inclined portions face each other in a direction orthogonal to the inflow direction, so that the distance between the inclined portion decreases in the downstream direction. This increases the pressure loss.

The conventional air-conditioning register described above therefore has room for improvement concerning pressure loss reduction in the neutral positions for enhanced air conditioning performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an air-conditioning register includes a retainer defining a vent passage including an outlet at a downstream end in a flow direction of air-conditioning air, two fins disposed upstream of the outlet in the vent passage, and an actuation mechanism. The flow direction that is changed by the fins includes an inflow direction, the inflow direction being the flow direction of the air-conditioning air immediately before entering between the fins. Positions of the fins that cause the air-conditioning air to be blown out from the outlet in the inflow direction are defined as neutral positions. Positions of the fins that cause the air-conditioning air to be blown out from the outlet in a direction inclined with respect to the inflow direction are defined as inclined positions. The actuation mechanism is configured to move the fins between the neutral positions and the inclined positions. When the fins are in the in the neutral positions, the actuation mechanism causes the fins to extend in the inflow direction and face each other in a direction orthogonal to the inflow direction. When the fins are in the inclined positions, the actuation mechanism moves the fins to separate locations respectively located upstream and downstream from the neutral positions, and tilts the fins with respect to the inflow direction such that downstream sides of the fins are located inward in the vent passage.

Other features and aspects will be apparent from the following detailed description, the drawings, and the claims.

### BRIEF DESCRIPTION OF THE DRAWINGS

FIG. 1 is a front view of an air-conditioning register according to one embodiment in which both downstream fins are in upward inclined positions, as viewed from the downstream side.

FIG. 2 is a cross-sectional side view showing the air-conditioning register of the above embodiment in which both downstream fins are in neutral positions, taken along a vertical plane extending between a link member and a left vertical wall portion.

FIG. 3 is a cross-sectional side view of the air-conditioning register in which the link member, an operation knob, an upstream transmission mechanism, and the like in FIG. 2 are omitted.

FIG. 4 is a diagram illustrating the positional relationship between upstream cam grooves and upstream shafts, and the positional relationship between downstream cam grooves and downstream shafts in a state in which the downstream fins are in the neutral positions in the above embodiment.

FIG. 5 is a cross-sectional side view (end view) of the air-conditioning register of the above embodiment in which the downstream fins are in the neutral positions, taken along a vertical plane extending through the operation knob.

FIG. 6 is a perspective view of the downstream fins and the operation knob of the above embodiment.

FIG. 7 is a perspective view of the downstream fins, the link member, the operation knob of the above embodiment.

FIG. 8 is a diagram corresponding to FIG. 2, and is a cross-sectional side view of the air-conditioning register in which the downstream fins are in upward inclined positions.

FIG. 9 is a diagram corresponding to FIG. 3, and is a cross-sectional side view of the air-conditioning register in which the link member, the operation knob, the upstream transmission mechanism, and the like in FIG. 8 are omitted.

FIG. 10 is a diagram corresponding to FIG. 4 and illustrating the positional relationship between the upstream cam grooves and the upstream shafts and the positional relationship between the downstream cam grooves and the downstream shafts in a state in which the downstream fins are in the upward inclined positions.

FIG. 11 is a diagram corresponding to FIG. 5, and is a cross-sectional side view (end view) of the air-conditioning register in which the downstream fins are in the upward inclined positions.

FIG. 12 is a diagram corresponding to FIG. 2, and is a cross-sectional side view of the air-conditioning register in which the downstream fins are in downward inclined positions.

FIG. 13 is a diagram corresponding to FIG. 3, and is a cross-sectional side view of the air-conditioning register in which the link member, the operation knob, the upstream transmission mechanism, and the like in FIG. 12 are omitted.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Referring to the drawings, an air-conditioning register for a vehicle according to one embodiment is now described.

In the following description, the traveling direction (forward driving direction) of the vehicle is referred to as a front direction, the reverse driving direction is referred to as a rear direction, and the height direction is referred to as a vertical direction. The vehicle width direction (lateral direction) is defined as viewed from the rear side of the vehicle.

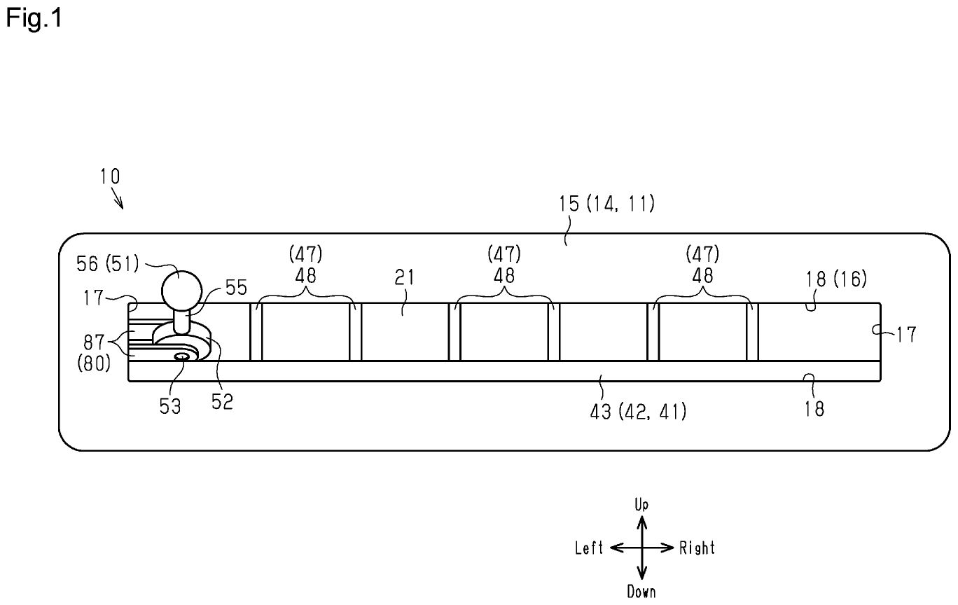

In the passenger compartment, an instrument panel is provided in front of the front seats (the driver's seat and the passenger seat) of the vehicle. An air-conditioning register 10 shown in FIG. 1 is set in each of the central portion and side portions, for example, in the lateral direction of the instrument panel. The main function of the air-conditioning register 10 is to change the direction of air-conditioning air A1 (see FIGS. 3, 9, and 13) that is sent from an air conditioner and to be blown out into the passenger compartment.

As shown in FIGS. 1 to 3, the air-conditioning register 10 includes a retainer 11, two downstream fins 31 and 41, multiple upstream fins 47, an operation knob 51, an actuation mechanism M1, and an upstream transmission mechanism 90. The components of the air-conditioning register 10 are now described.

### Retainer 11

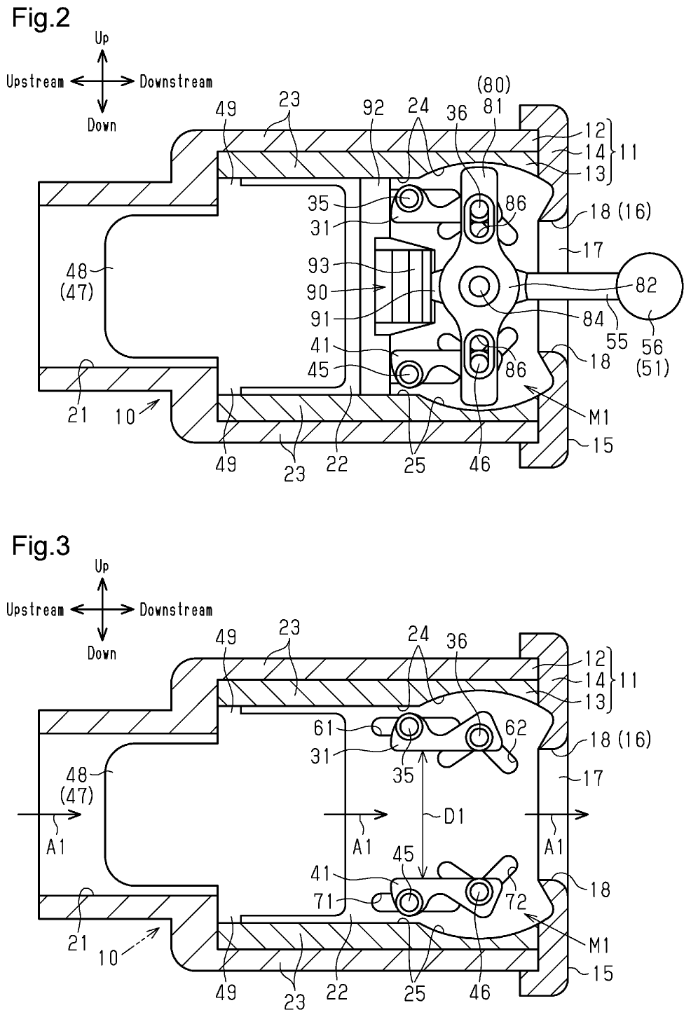

As shown in FIGS. 2 and 3, the retainer 11 connects a ventilation duct (not shown) of the air conditioner (not shown) and an opening formed in the instrument panel (not shown). The retainer 11 includes an outer retainer member 12, an inner retainer member 13, and a bezel 14. The retainer 11 includes a vent passage 21, through which the air-conditioning air A1 flows.

The vent passage 21 is surrounded by four wall portions of the retainer 11. These four wall portions include two vertical wall portions 22 facing each other in the lateral direction and two lateral wall portions 23 facing each other in the vertical direction.

With respect to the flow direction of the air-conditioning air A1, the direction toward the air conditioner is referred to as “upstream”, and the direction away from the air conditioner is referred to as “downstream.” In the description of the positional relationship of the components of the air-conditioning register 10, of the thickness direction of the vertical wall portions 22 and the lateral wall portions 23 of the retainer 11, the direction toward the vent passage 21 is referred to as “inward”, “inside” and the like. The thickness direction includes a direction away from the vent passage 21, which is referred to as “outward”, “outside”, and the like.

Each of the outer and inner retainer members 12 and 13 has the shape of a tube with open upstream and downstream ends and has a greater dimension in the lateral direction than in the vertical direction. The inner retainer member 13 is arranged inside the downstream portion of the outer retainer member 12.

The bezel 14 is attached to the downstream ends of the outer and inner retainer members 12 and 13. The downstream end surface of the bezel 14 forms a decorative surface 15 of the air-conditioning register 10 (see FIG. 1). The bezel 14 includes an outlet 16, which forms the downstream end of the vent passage 21. The shape of the outlet 16 will be described below.

### Downstream Fins 31 and 41

As shown in FIGS. 3, 5, and 6, two downstream fins 31 and 41 function to vertically change the direction of the air-conditioning air A1 to be blown out from the outlet 16. The two downstream fins 31 and 41 correspond to two fins in the claims. Both downstream fins 31 and 41 are located upstream of the outlet 16 in the vent passage 21 and at mutually different locations in the vertical direction.

The upper downstream fin 31 includes a plate-shaped portion 32, a bulging portion 33, multiple ribs 34, two upstream shafts 35, and two downstream shafts 36. The plate-shaped portion 32 extends in the lateral direction, which is the lengthwise direction, and in the flow direction inside the inner retainer member 13. The bulging portion 33 bulges upward from the downstream edge of the plate-shaped portion 32. The bulging portion 33 extends over the entire length in the lateral direction of the plate-shaped portion 32. Each rib 34 is plate-shaped. The ribs 34 are formed on the upper surface of the plate-shaped portion 32 at locations spaced apart from each other in the lateral direction. One of the purposes of the ribs 34 is to increase the rigidity of the plate-shaped portion 32.

The two upstream shafts 35 extend away from each other in the lateral direction from the upstream ends of opposite end surfaces in the lateral direction of the plate-shaped portion 32. The two downstream shafts 36 extend away from each other in the lateral direction from the downstream ends of opposite end surfaces in the lateral direction of the plate-shaped portion 32. The upstream shaft 35 and the downstream shaft 36 on the same side in the lateral direction are spaced apart from each other in the flow direction.

The upper downstream fin 31 is supported on the upper portion of the left vertical wall portion 22 of the inner retainer member 13 at the left upstream shaft 35 and the left downstream shaft 36. The upper downstream fin 31 is also supported on the upper portion of the right vertical wall portion 22 of the inner retainer member 13 at the right upstream shaft 35 and the right downstream shaft 36. Details will be described below.

The lower downstream fin 41 includes a plate-shaped portion 42, a bulging portion 43, multiple ribs (not shown), two upstream shafts 45, and two downstream shafts 46. The plate-shaped portion 42 extends in the lateral direction, which is the lengthwise direction, and in the flow direction inside the inner retainer member 13. The bulging portion 43 bulges downward from the downstream edge of the plate-shaped portion 42. The bulging portion 43 extends over the entire length in the lateral direction of the plate-shaped portion 42. Each rib is plate-shaped. Multiple ribs are formed on the lower surface of the plate-shaped portion 42 at locations spaced apart from each other in the lateral direction. One of the purposes of the ribs is to increase the rigidity of the plate-shaped portion 42.

The two upstream shafts 45 extend away from each other in the lateral direction from the upstream ends of opposite end surfaces in the lateral direction of the plate-shaped portion 42. The two downstream shafts 46 extend away from each other in the lateral direction from the downstream ends of opposite end surfaces in the lateral direction of the plate-shaped portion 42.

The lower downstream fin 41 is supported on the lower portion of the left vertical wall portion 22 of the inner retainer member 13 at the left upstream shaft 45 and the left downstream shaft 46. The lower downstream fin 41 is also supported on the lower portion of the right vertical wall portion 22 of the inner retainer member 13 at the right upstream shaft 45 and the right downstream shaft 46. Details will be described below.

### Inflow Direction

Referring to FIG. 3, the flow direction to be changed vertically by the downstream fins 31 and 41 includes an inflow direction of the air-conditioning air A1 immediately before entering between the downstream fins 31 and 41. In FIG. 3, the direction from left to right is the inflow direction.

### Neutral Position and Inclined Position

Each downstream fin 31, 41 can rotate and move between a neutral position and an inclined position. The downstream fins 31 and 41 assume the neutral positions to cause the air-conditioning air A1 to be blown out from the outlet 16 in the inflow direction. In the neutral positions, the downstream fins 31 and 41 extend in the inflow direction and face each other in the vertical direction, which is a direction orthogonal to the inflow direction.

As shown in FIGS. 9 and 13, the downstream fins 31 and 41 assume inclined positions to cause the air-conditioning air A1 to be blown out from the outlet 16 in a direction inclined with respect to the inflow direction. The inclined positions include upward inclined positions (FIG. 9) assumed by the downstream fins 31 and 41 to cause the air-conditioning air A1 to be blown out from the outlet 16 diagonally upward to the rear side, and downward inclined positions (FIG. 13) assumed by the downstream fins 31 and 41 to cause the air-conditioning air A1 to be blown diagonally downward to the rear. When the upward inclined position and the downward inclined position do not need to be distinguished, they may simply be referred to as the inclined positions.

As shown in FIG. 9, in the upward inclined position, the upper downstream fin 31 is at a location shifted upstream from the neutral position (FIG. 3) and inclined with respect to the inflow direction such that the downstream side is located inward in the vent passage 21.

Also, the lower downstream fin 41 is at a location shifted downstream from the neutral position and inclined with respect to the inflow direction such that the downstream side is located inward in the vent passage 21.

As shown in FIG. 13, in the downward inclined position, the upper downstream fin 31 is at a location shifted downstream from the neutral position and inclined with respect to the inflow direction such that the downstream side is located inward in the vent passage 21. Also, the lower downstream fin 41 is at a location shifted upstream from the neutral position and inclined with respect to the inflow direction such that the downstream side is located inward in the vent passage 21.

### Outlet 16

As shown in FIGS. 1 to 3, the outlet 16 includes two side portions facing each other. The side portions extend in the same direction as the lengthwise direction in which the plate-shaped portions 32 and 42 extend, or in the lateral direction in this example. The outlet 16 is shaped such that the side portions are longer than the distance between the side portions.

In this embodiment, the outlet 16 has the shape of a horizontally elongated rectangle, which is longer in the lateral direction than in the vertical direction. The outlet 16 includes two short side portions 17, which face each other in the lateral direction, and two long side portions 18, which face each other in the vertical direction orthogonal to the direction in which the short side portions 17 face each other. The long side portions are longer than the short side portions 17. The two long side portions 18 correspond to the above-mentioned side portions.

### Accommodation Chambers 24 and 25

As shown in FIGS. 2 and 3, accommodation chambers 24 and 25 are located upstream of the outlet 16 of the retainer 11 and outward of the outlet 16 in the direction in which the long side portions 18 face each other. An accommodation chamber 24 is located upstream of the outlet 16 of the retainer 11 and at a position higher than the outlet 16. An accommodation chamber 25 is located upstream of the outlet 16 of the retainer 11 and at a position lower than the outlet 16.

### Positional Relationship Between Downstream Fins 31 and 41 and Accommodation Chambers 24 and 25

The positions of the downstream fins 31 and 41 in the vertical direction are set to locations that satisfy the following Condition 1.

Condition 1: As shown in FIGS. 3 and 5, when the downstream fins 31 and 41 are in the neutral positions, at least portions of the downstream fins 31 and 41 in the vertical direction, which is the thickness direction of the plate-shaped portions 32 and 42, are accommodated in the accommodation chambers 24 and 25.

As for the upper downstream fin 31, at least an upper portion of the downstream fin 31 is accommodated in the upper accommodation chamber 24.

As for the lower downstream fin 41, at least a lower portion of the downstream fin 41 is accommodated in the lower accommodation chamber 25.

In this embodiment, the position of the upper downstream fin 31 in the vertical direction is set such that the downstream fin 31 in the neutral position is entirely accommodated in the upper accommodation chamber 24. Also, the position of the lower downstream fin 41 in the vertical direction is set such that the downstream fin 41 in the neutral position is entirely accommodated in the lower accommodation chamber 25.

### Upstream Fins 47

As shown in FIGS. 1 to 3, the upstream fins 47 function to laterally change the direction of the air-conditioning air A1 to be blown out from the outlet 16, for example. The upstream fins 47 are located upstream of the downstream fins 31 and 41 in the vent passage 21. The upstream fins 47 are arranged parallel to each other and spaced apart at equal intervals in the lateral direction.

Each upstream fin 47 includes a plate-shaped portion 48 and two fin shafts 49. The plate-shaped portion 48 of each upstream fin 47 extends in the vertical direction and in the flow direction in the vent passage 21. The two fin shafts 49 of each upstream fin 47 extend away from each other in the vertical direction from opposite end surfaces in the vertical direction of the plate-shaped portion 48. The fin shafts 49 are supported by the respective lateral wall portions 23 of the inner retainer member 13. Each upstream fin 47 can tilt in the lateral direction about the two fin shafts 49.

### Operation Knob 51

Referring to FIGS. 2, 6, and 7, an operation knob 51 may be operated by an occupant to change the blow direction of the air-conditioning air A1 from the outlet 16. The operation knob 51 includes a base portion 52, a shaft portion 55, and a grip portion 56. The base portion 52 is disc-shaped and includes two shaft sections 53 (see FIG. 5) extending in the vertical direction. The grip portion 56 is a portion to be gripped by an occupant, and is located downstream of the bezel 14. The shaft portion 55 is disposed through the outlet 16 to extend on the upstream and downstream sides of the bezel 14. The shaft portion 55 couples the base portion 52 to the grip portion 56.

To change the blow direction vertically, the operation knob 51 is operated in the vertical direction. To change the blow direction laterally, the operation knob 51 is operated in the lateral direction.

### Actuation Mechanism M1

The actuation mechanism M1 is a mechanism for moving the downstream fins 31 and 41 between the neutral positions and the inclined positions. As shown in FIG. 3, in the neutral position, the actuation mechanism M1 causes the two downstream fins 31 and 41 to extend in the inflow direction and face each other in a direction orthogonal to the inflow direction. As shown in FIG. 9, in the upward inclined position, the actuation mechanism M1 causes the upper downstream fin 31 to be moved to a location shifted downstream from the neutral position and inclined with respect to the inflow direction such that the downstream side is lower. In the upward inclined position, the actuation mechanism M1 causes the lower downstream fin 41 to be moved to a location shifted downstream from the neutral position and inclined with respect to the inflow direction such that the downstream side is higher.

As shown in FIG. 13, in the downward inclined position, the actuation mechanism M1 causes the upper downstream fin 31 to be moved to a location shifted downstream from the neutral position and inclined with respect to the inflow direction such that the downstream side is lower. In the downward inclined position, the actuation mechanism M1 causes the lower downstream fin 41 to be moved to a location shifted upstream from the neutral position and inclined with respect to the inflow direction such that the downstream side is higher.

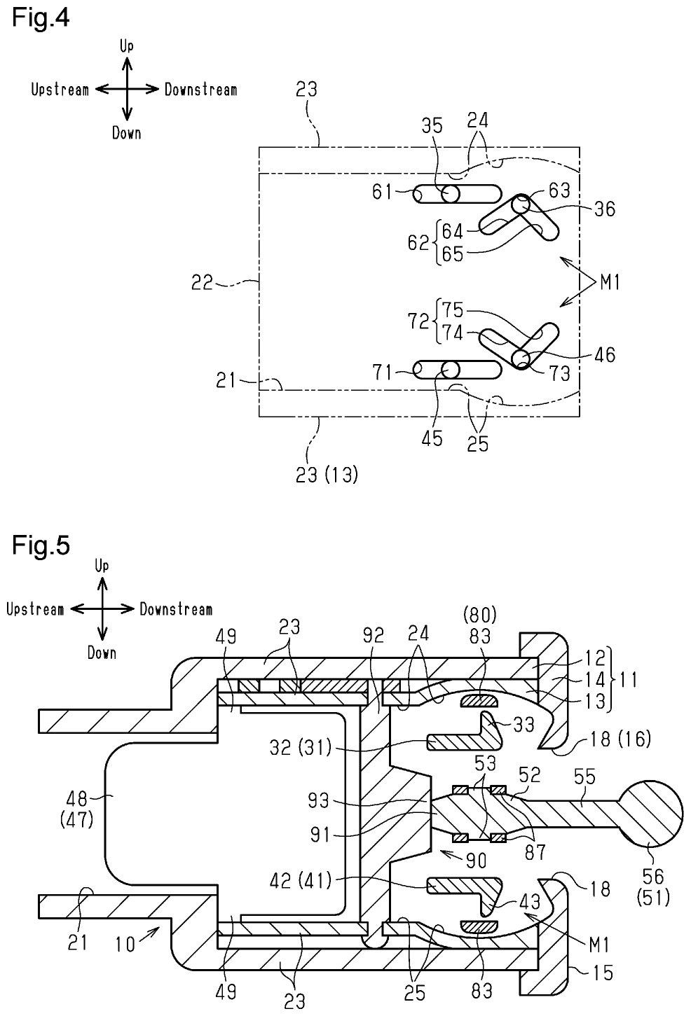

As shown in FIGS. 3 and 4, the actuation mechanism M1 includes two sets of an upstream cam groove and a downstream cam groove arranged in the vertical direction. The upper set includes an upper upstream cam groove 61 and an upper downstream cam groove 62. The lower set includes a lower upstream cam groove 71 and a lower downstream cam groove 72. The left and right vertical wall portions 22 each include an upper set and a lower set.

### Upper Upstream Cam Groove 61 and Upper Downstream Cam Groove 62

The upstream cam grooves 61 and the downstream cam grooves 62 are formed in the upper portions of the left and right vertical wall portions 22 of the inner retainer member 13, and open to the vent passage 21. The upstream cam groove 61 extends linearly in the inflow direction at a location separated upstream from the bezel 14. The upstream cam groove 61 is formed at a location higher than the upper long side portion 18 of the outlet 16 in the vertical direction. The upstream cam groove 61 has a groove width that is slightly greater than the diameter of the upstream shaft 35. The “groove width that is slightly greater” as used herein refers to a groove width that allows the upstream shaft 35 to rotate and move within the upstream cam groove 61 in a state free of rattling or in a similar state.

The above feature of the groove width is also applicable when the groove widths of the downstream cam grooves 62 and 72 and the upstream cam groove 71, which will be described below, are described as a groove width that is slightly greater. Also, the above feature of the groove width is also applicable when the width of a slot 86, which will be described below, is described as a width that is slightly greater.

The downstream cam groove 62 includes a middle portion 63 in the inflow direction, an upstream inclined portion 64, which forms the section upstream of the middle portion 63, and a downstream inclined portion 65, which forms the section downstream of the middle portion 63. The middle portion 63 is located downstream of the upstream cam groove 61 and at a position lower than the upstream cam groove 61, or inward of the upstream cam groove 61 in the vent passage 21. The upstream inclined portion 64 is inclined with respect to the inflow direction such that the upstream side is located inward in the vent passage 21. The upstream portion of the upstream inclined portion 64 is located below the downstream portion of the upstream cam groove 61. The downstream inclined portion 65 is inclined with respect to the inflow direction such that the downstream side is located inward in the vent passage 21.

In this manner, in the downstream cam groove 62, the upstream inclined portion 64 and the downstream inclined portion 65 are inclined in opposite directions with respect to the inflow direction, and are connected at the middle portion 63. The downstream cam groove 62 has a groove width slightly greater than the diameter of the downstream shaft 36.

The upstream shaft 35 is engaged with the upstream cam groove 61 in a rotational and movable manner. The downstream shaft 36 is engaged with the downstream cam groove 62 in a rotational and movable manner.

### Lower Upstream Cam Groove 71 and Lower Downstream Cam Groove 72

The upstream cam grooves 71 and the downstream cam grooves 72 are formed in the lower portions of the left and right vertical wall portions 22 of the inner retainer member 13, and open to the vent passage 21. The upstream cam groove 71 extends linearly in the inflow direction at a location separated upstream from the bezel 14. The upstream cam groove 71 is formed at a location lower than the lower long side portion 18 of the outlet 16 in the vertical direction. The upstream cam groove 71 has a groove width that is slightly greater than the diameter of the upstream shaft 45.

The downstream cam groove 72 includes a middle portion 73 in the inflow direction, an upstream inclined portion 74, which is upstream of the middle portion 73, and a downstream inclined portion 75, which is downstream of the middle portion 73. The middle portion 73 is located downstream of the upstream cam groove 71 and at a position higher than the upstream cam groove 71, or inward of the upstream cam groove 71 in the vent passage 21. The upstream inclined portion 74 is inclined with respect to the inflow direction such that the upstream side is located inward in the vent passage 21. The upstream portion of the upstream inclined portion 74 is located above the downstream portion of the upstream cam groove 71. The downstream inclined portion 75 is inclined with respect to the inflow direction such that the downstream side is located inward in the vent passage 21.

In this manner, in the downstream cam groove 72, the upstream inclined portion 74 and the downstream inclined portion 75 are inclined in opposite directions with respect to the inflow direction, and are connected at the middle portion 73. The downstream cam groove 72 has a groove width slightly greater than the diameter of the downstream shaft 46.

The upstream shaft 45 is engaged with the upstream cam groove 71 in a rotational and movable manner. The downstream shaft 46 is engaged with the downstream cam groove 72 in a rotational and movable manner.

### Relationship Between Positions of Upstream Shafts 35 and 45 and Downstream Shafts 36 and 46 and Positions and Inclinations of Downstream Fins 31 and 41

The downstream fins 31 and 41 are placed in the neutral positions when the upstream shafts 35 and 45 are placed in middle sections in the inflow direction of the upstream cam grooves 61 and 71 and the downstream shafts 36 and 46 are placed in the middle portions 63 and 73 of the downstream cam grooves 62 and 72.

Referring to FIGS. 9 and 13, the downstream shaft 36, 46 is placed in a middle section in the inflow direction of the upstream inclined portion 64, 74, and the upstream shaft 35, 45 is placed upstream of the middle section in the inflow direction of the upstream cam groove 61, 71. This causes the downstream fin 31, 41 to be at a location shifted upstream from the neutral position and inclined with respect to the inflow direction such that the downstream side is located inward in the vent passage 21. When the downstream shaft 36, 46 is placed at the upstream end of the upstream inclined portion 64, 74, and the upstream shaft 35, 45 is placed at the upstream end of the upstream cam groove 61, 71, the downstream fin 31, 41 is in the inclined position.

The downstream shaft 36, 46 is placed in a middle section in the inflow direction of the downstream inclined portion 65, 75, and the upstream shaft 35, 45 is placed downstream of the middle section in the inflow direction of the upstream cam groove 61, 71. This causes the downstream fin 31, 41 to be at a location shifted downstream from the neutral position and inclined with respect to the inflow direction such that the downstream side is located inward in the vent passage 21. When the downstream shaft 36, 46 is placed at the downstream end of the downstream inclined portion 65, 75, and the upstream shaft 35, 45 is placed at the downstream end of the upstream cam groove 61, 71, the downstream fin 31, 41 is in the inclined position.

The actuation mechanism M1 further includes a downstream transmission mechanism portion 80, which transmits the movement of the operation knob 51 to the downstream fins 31 and 41.

### Downstream Transmission Mechanism Portion 80

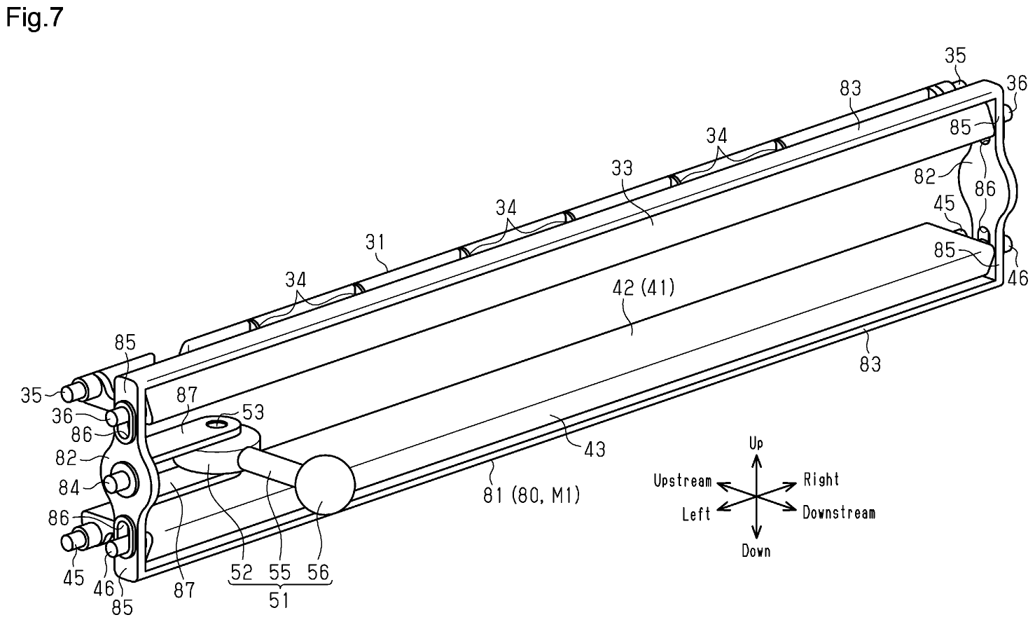

As shown in FIG. 7, the downstream transmission mechanism portion 80 includes a link member 81 and two support plate portions 87.

The link member 81 includes two rotation portions 82, two bridging portions 83, and support shaft portions 84 for the respective rotation portions 82. FIG. 7 shows only one of the support shaft portions 84. Each rotation portion 82 is arranged between the downstream fins 31 and 41 and one of the left and right vertical wall portions 22 of the inner retainer member 13 that is adjacent to the downstream fins 31 and 41. Each rotation portion 82 has two extension portions 85 extending from the support shaft portion 84 in opposite radial directions.

As shown in FIGS. 5 and 7, each bridging portion 83 extends in the lateral direction between the corresponding downstream fin 31, 41 and one of the upper and lower lateral wall portions 23 of the inner retainer member 13 that is adjacent to the downstream fin 31, 41. The bridging portions 83 extend between the sections of the left extension portions 85 that are farthest from the support shaft portion 84 and the sections of the right extension portions 85 that are farthest from the support shaft portion 84.

As shown in FIGS. 2 and 7, the two support shaft portions 84 extend away from each other in the lateral direction from the central portions of the respective rotation portions 82. The support shaft portions 84 of the rotation portions 82 are rotationally supported by the vertical wall portions 22 of the inner retainer member 13. The support point at which each support shaft portion 84 is supported by the corresponding vertical wall portion 22 is set in the central portion in the vertical direction. In the flow direction, the support point is set to the same position as the middle portions 63 and 73 of the downstream cam grooves 62 and 72, or to a certain area including this position.

Each extension portion 85 includes a slot 86 at a position separated from the support shaft portion 84 by a certain distance. The slot 86 is elongated in a radial direction about the support shaft portion 84 and extends through in the lateral direction. The slot 86 has a width and a length. The length refers to the dimension in the direction in which the slot 86 is elongated. The width is the dimension in a direction orthogonal to the direction in which the slot 86 is elongated. The width of the slots 86 is set to be slightly greater than the diameter of the downstream shafts 36 and 46. The length of the slots 86 is set so as not to interfere with the movements of the downstream shafts 36 and 46 in the downstream cam grooves 62 and 72 when the downstream fins 31 and 41 move between the neutral positions and the inclined positions.

The downstream shafts 36 and 46 of the downstream fins 31 and 41 are inserted in the slots 86 and also engaged with the downstream cam grooves 62 and 72. The downstream shaft 36 of the upper downstream fin 31 and the downstream shaft 46 of the lower downstream fin 41 are thus connected by the link member 81 in a manner that enables power transmission.

As shown in FIGS. 5 and 7, the two support plate portions 87 extend from the left rotation portion 82 toward the right rotation portion 82 in parallel with and spaced apart from each other. The support plate portions 87 sandwich the base portion 52 of the operation knob 51 from opposite sides in the vertical direction. The base portion 52 includes two shaft sections 53 rotationally supported by the respective support plate portions 87.

### Upstream Transmission Mechanism 90

As shown in FIGS. 2 and 5, an upstream transmission mechanism 90 transmits movements in the lateral direction of the operation knob 51, that is, rotational movements in the lateral direction about the shaft sections 53, to the upstream fins 47. Through this transmission, the upstream transmission mechanism 90 tilts all upstream fins 47 in synchronization in the lateral direction.

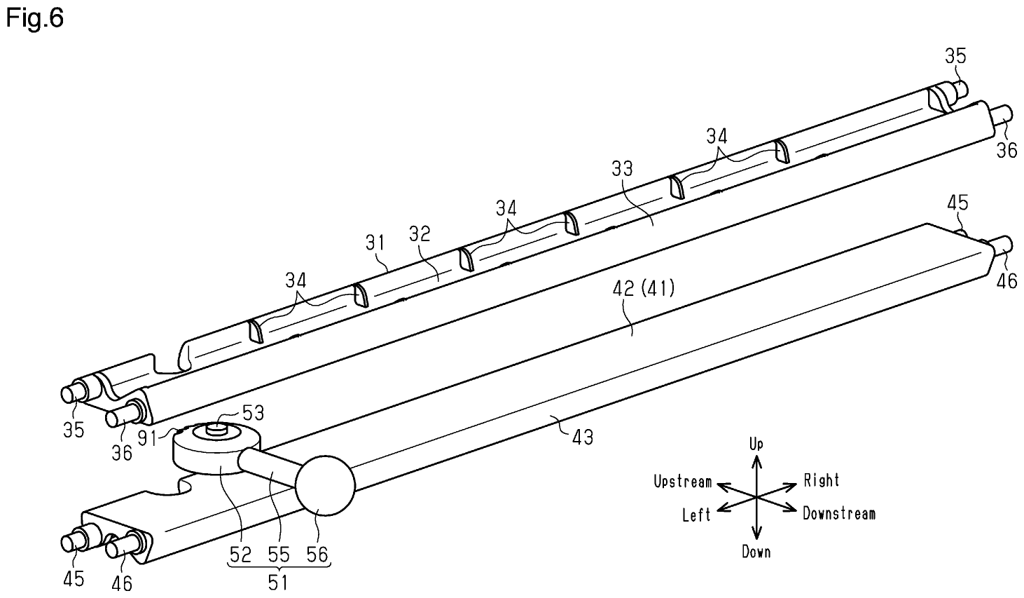

Any mechanism portion that achieves the above purpose may be used as the upstream transmission mechanism 90 without any limitations. Such a mechanism portion may be a combination of gears, for example. FIGS. 2 and 5 show a combination of some gears of the upstream transmission mechanism 90. The base portion 52 includes a drive gear portion 91 with multiple teeth arranged along an arc about the shaft sections 53 (see FIG. 6).

A shaft portion 92 extends in the vertical direction on the upstream side of the two support plate portions 87. The ends in the vertical direction of the shaft portion 92 are rotationally supported by the upper and lower lateral wall portions 23 of the inner retainer member 13. A middle section in the vertical direction of the shaft portion 92 includes a sectorial driven gear portion 93. The driven gear portion 93 includes teeth arranged along an arc about the shaft portion 92.

The drive gear portion 91 is meshed with the driven gear portion 93. When the drive gear portion 91 is rotated, the rotation is transmitted to the driven gear portion 93 and rotates the shaft portion 92.

Operation of the present embodiment configured as described above is now described.

The following description on operation uses an example in which the shaft portion 55 of the operation knob 51 and the plate-shaped portion 48 of each upstream fin 47 are parallel to the vertical wall portions 22 as shown in FIGS. 2 and 5. The air-conditioning air A1 flowing into the retainer 11 flows along the upstream fins 47 and the vertical wall portions 22 in the section upstream of the downstream fins 31 and 41. The air-conditioning air A1 flows straight without changing its flow direction in the lateral direction.

### Position and Inclination of Downstream Fins 31 and 41

As shown in FIGS. 2 to 4, the upstream shafts 35 and 45 of the downstream fins 31 and 41 can rotate and move only within the engaged upstream cam grooves 61 and 71. The downstream shafts 36 and 46 of the downstream fin 31 and 41 can rotate and move only within the engaged downstream cam grooves 62 and 72. When the engagement positions of the downstream shafts 36 and 46 in the downstream cam grooves 62 and 72 are determined, the engagement positions of the upstream shafts 35 and 45 in the upstream cam grooves 61 and 71 are also determined. This determines the positions and inclinations of the downstream fins 31 and 41.

### Operation of Downstream Fins 31 and 41

The upstream shafts 35 and 45 of the downstream fins 31 and 41 rotate and move in the upstream cam grooves 61 and 71, changing their positions in the inflow direction while maintaining their positions in the vertical direction, which is a direction orthogonal to the inflow direction. When the downstream shafts 36 and 46 are placed in the middle portions 63 and 73 of the downstream cam grooves 62 and 72, the upstream shafts 35 and 45 are placed in the middle sections in the inflow direction of the upstream cam grooves 61 and 71. At this time, the downstream fins 31 and 41 are in the neutral positions.

As the downstream shafts 36 and 46 of the downstream fins 31 and 41 rotate and move from the middle portions 63 and 73 along the upstream inclined portions 64 and 74, their positions in the vertical direction and in the inflow direction change. The downstream fins 31 and 41 move to locations that are shifted upstream from the neutral positions and are inclined with respect to the inflow direction such that downstream sides are located inward in the vent passage 21.

Also, as the downstream shafts 36 and 46 rotate and move from the middle portions 63 and 73 along the downstream inclined portions 65 and 75, their positions in the vertical direction and in the inflow direction change. The downstream fins 31 and 41 move to locations that are shifted downstream from the neutral positions and are inclined with respect to the inflow direction such that downstream sides are located inward in the vent passage 21.

The link member 81 shown in FIG. 7 is rotatable about the two support shaft portions 84. The link member 81 rotates when the operation knob 51 is operated in a vertical direction. The rotation of the link member 81 is transmitted to the downstream shafts 36 and 46 of both downstream fins 31 and 41.

Each downstream shaft 36, 46 is inserted in the slot 86 and the downstream cam groove 62, 72. The downstream shaft 36, 46 is at a location where the slot 86 is aligned with the downstream cam groove 62, 72. The downstream cam groove 62, 72 does not move, whereas the slot 86 moves along an arc about the support shaft portion 84 as the link member 81 rotates. The movement of the slot 86 changes the section of the downstream cam groove 62, 72 that is aligned with the slot 85, and thus the position of the downstream shaft 36, 46. The downstream shaft 36, 46 rotates while moving in the downstream cam groove 62, 72.

As the position of the downstream shaft 36, 46 in the downstream cam groove 62, 72 changes, the position of the upstream shaft 35, 45 in the upstream cam groove 61, 71 changes accordingly. This changes the position and inclination of the downstream fin 31, 41. The upstream shaft 35, 45 rotates while moving in the upstream cam groove 61, 71. In this manner, the two downstream fins 31 and 41 may be placed in any of the neutral positions, the upward inclined positions, and the downward inclined positions.

Each rotation portion 82 includes two slots 86. These slots 86 receive the downstream shafts 36 and 46 of the downstream fins 31 and 41. Thus, the two downstream fins 31 and 41 change their positions and inclinations in a synchronous manner.

Also, both downstream fins 31 and 41 are movable between the neutral positions and the upward inclined positions by rotating and moving the upstream shafts 35 and 45 along the upstream cam grooves 61 and 71 and by rotating and moving the downstream shafts 36 and 46 along the downstream cam grooves 62 and 72. The downstream fins 31 and 41 are movable also between the neutral positions and the downward inclined positions. The downstream fins 31 and 41 may also be placed in intermediate positions between the neutral positions and the upward inclined positions, and in intermediate positions between the neutral positions and the downward inclined positions.

### Downstream Fins 31 and 41 in Neutral Positions

FIGS. 2 to 7 show a state in which the shaft portion 55 of the operation knob 51 is parallel to the lateral wall portions 23. The link member 81 is not tilted, and each rotation portion 82 extends in the vertical direction.

At this time, the middle portion 63 of the upper downstream cam groove 62 is aligned with the upper end of the upper slot 86. Also, the middle portion 73 of the lower downstream cam groove 72 is aligned with the lower end of the lower slot 86 (see FIG. 2).

As such, the downstream shafts 36 and 46 of the downstream fins 31 and 41 are held in the middle portions 63 and 73 of the downstream cam grooves 62 and 72. The upstream shafts 35 and 45 of the downstream fins 31 and 41 are held in the middle sections in the inflow direction of the upstream cam grooves 61 and 71. As a result, both downstream fins 31 and 41 are held in the neutral positions. In the neutral positions, the downstream fins 31 and 41 extend in the inflow direction and face each other in a direction orthogonal to the inflow direction.

The air-conditioning air A1 near the downstream fins 31 and 41 flows along the downstream fins 31 and 41, thereby maintaining the inflow direction as the flow direction. While the air-conditioning air A1 flows between the downstream fins 31 and 41, the flow direction is not changed significantly. The air-conditioning air A1 is blown out from the outlet 16 in the inflow direction.

As shown in FIG. 3, in the neutral positions, the distance D1 between the downstream fins 31 and 41 is constant or substantially constant at any position in the inflow direction. As such, the distance D1 at the downstream ends of the downstream fins 31 and 41 is wider than that in a conventional air-conditioning register in which the fins include inclined portions that are always inclined with respect to the inflow direction such that the downstream sides are located inward in the vent passage.

As shown in FIG. 5, in the neutral position, the entire upper downstream fin 31 in the thickness direction is accommodated in the upper accommodation chamber 24. Also, in the neutral position, the entire lower downstream fin 41 in the thickness direction is accommodated in the lower accommodation chamber 25. As a result, the entire downstream fins 31 and 41 in the thickness direction are located outward in the vertical direction of the outlet 16 on the upstream side.

### Downstream Fins 31 and 41 in Upward Inclined Positions

FIGS. 1 and 8 to 11 show a state in which the operation knob 51 is operated upward from the state shown in FIGS. 2 to 7 above, so that the shaft portion 55 is inclined with respect to the lateral wall portions 23 such that the downstream side is higher.

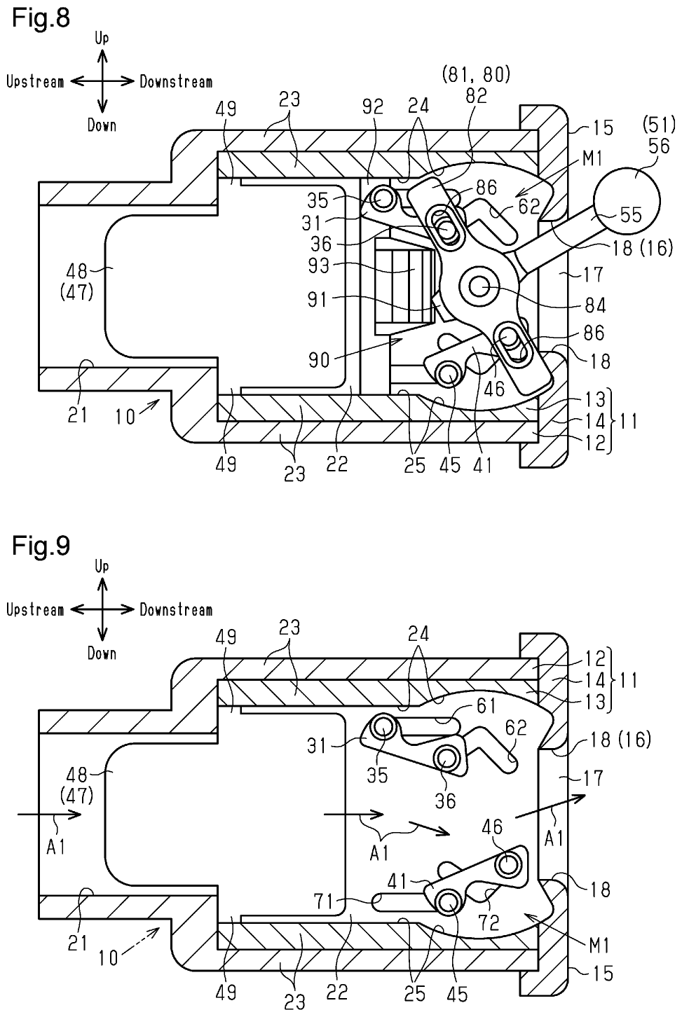

As shown in FIGS. 8 and 11, the link member 81 is inclined such that the upper side is located upstream. The same applies to the slots 86.

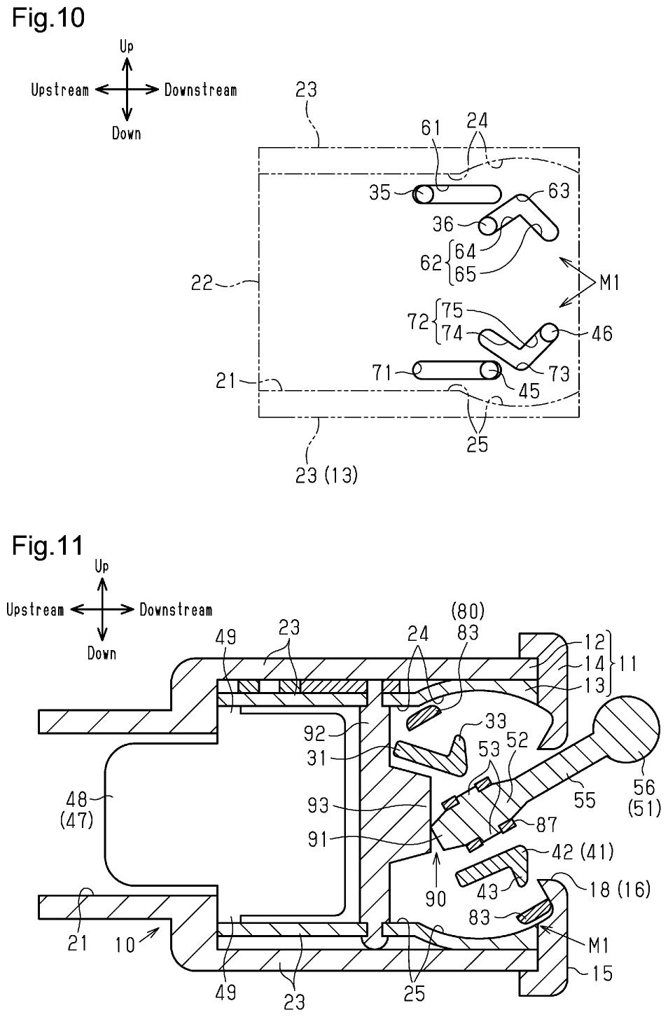

At this time, as shown in FIGS. 8 and 10, the upstream end of the upstream inclined portion 64 of the upper downstream cam groove 62 is aligned with a middle section in the vertical direction of the upper slot 86. The downstream shaft 36 of the upper downstream fin 31 is held at the upstream end of the upstream inclined portion 64. The upstream shaft 35 of the upper downstream fin 31 is held at the upstream end of the upstream cam groove 61. As shown in FIGS. 9 and 11, the upper downstream fin 31 is at a location shifted upstream from the neutral position and inclined with respect to the inflow direction such that the downstream side is located inward in the vent passage 21, or the downstream side is lower in this example.

Also, as shown in FIGS. 8 and 10, the downstream end of the downstream inclined portion 75 of the lower downstream cam groove 72 is aligned with the upper end of the lower slot 86. The downstream shaft 46 of the lower downstream fin 41 is held at the downstream end of the downstream inclined portion 75. The upstream shaft 45 of the lower downstream fin 41 is held at the downstream end of the upstream cam groove 71. As shown in FIGS. 9 and 11, the lower downstream fin 41 is at a location shifted downstream from the neutral position and inclined with respect to the inflow direction such that the downstream side is located inward in the vent passage 21, or the downstream side is higher in this example.

As described above, in the upward inclined positions, the two downstream fins 31 and 41 are both in an inclined state, with the upper downstream fin 31 located upstream of the lower downstream fin 41. Furthermore, the upper downstream fin 31 and the lower downstream fin 41 are inclined in opposite directions.

The air-conditioning air A1 flowing near the lower downstream fins 41 located on the downstream side changes its flow direction to the inner side of the vent passage 21, or diagonally upward to the rear side in this example, as it flows along the downstream fin 41. The air-conditioning air A1 is blown out from the outlet 16 diagonally upward to the rear side.

The air-conditioning air A1 flowing near the upper downstream fins 31 located on the upstream side changes its flow direction to the inner side of the vent passage 21, or diagonally downward to the rear side in this example, as it flows along the downstream fins 31. Part of the air-conditioning air A1 flowing along the downstream fin 31 impinges on the downstream fin 41 and flows along the downstream fins 41, thereby changing its flow direction diagonally upward to the rear side.

As a result, the amount of the air-conditioning air A1 that flows along the lower downstream fin 41 and then blows out from the outlet 16 diagonally upward to the rear side is increased by the air-conditioning air A1 whose flow direction is changed by the downstream fin 31.

### Downstream Fins 31 and 41 in Downward Inclined Positions

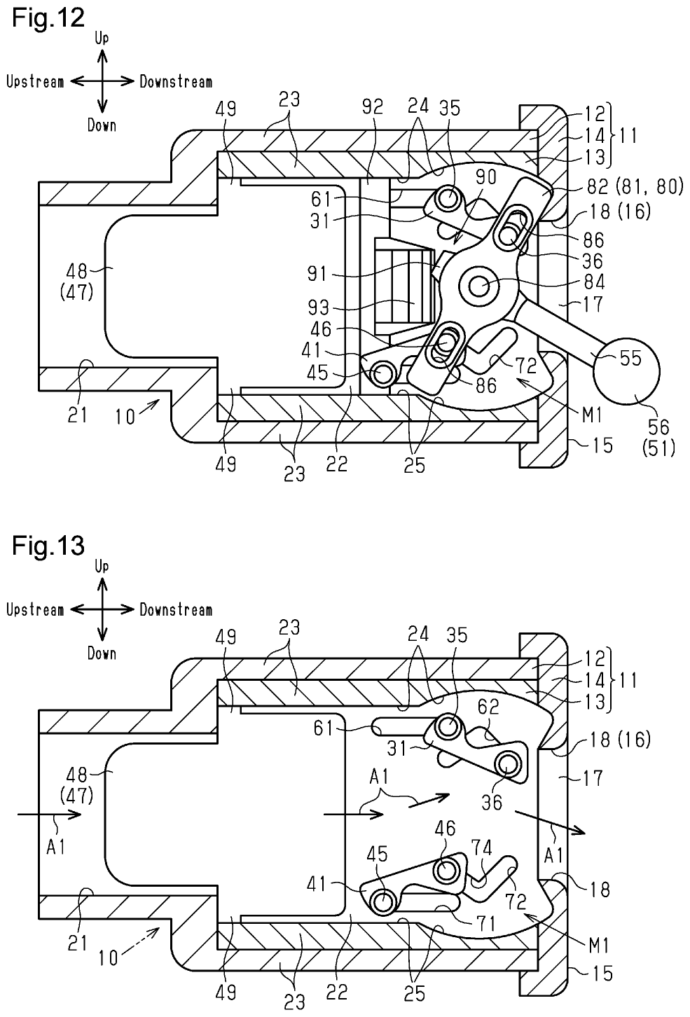

FIGS. 12 and 13 show a state in which the operation knob 51 is operated downward from the state shown in FIGS. 2 to 7, so that the shaft portion 55 is inclined with respect to the lateral wall portions 23 such that the downstream side is lower.

The link member 81 is inclined such that the upper side is located downstream. The same applies to the slots 86.

At this time, the downstream end of the downstream inclined portion 65 of the upper downstream cam groove 62 is aligned with the lower end of the upper slot 86. The downstream shaft 36 of the upper downstream fin 31 is held at the downstream end of the downstream inclined portion 65. The upstream shaft 35 of the upper downstream fin 31 is held at the downstream end of the upstream cam groove 61. The upper downstream fin 31 is at a location shifted downstream from the neutral position and inclined with respect to the inflow direction such that the downstream side is located inward in the vent passage 21, or the downstream side is lower in this example.

Also, the upstream end of the upstream inclined portion 74 of the lower downstream cam groove 72 is aligned with a middle section in the vertical direction of the lower slot 86. The downstream shaft 46 of the lower downstream fin 41 is held at the upstream end of the upstream inclined portion 74. The upstream shaft 45 of the lower downstream fin 41 is held at the upstream end of the upstream cam groove 71. The lower downstream fin 41 is at a location shifted upstream from the neutral position and inclined with respect to the inflow direction such that the downstream side is located inward in the vent passage 21, or the downstream side is higher in this example.

As described above, in the downward inclined positions, the two downstream fins 41 and 31 are both in the inclined state, with the lower downstream fin 41 located upstream of the upper downstream fin 31. Furthermore, the lower downstream fin 41 and the upper downstream fin 31 are inclined in opposite directions.

The air-conditioning air A1 flowing near the upper downstream fin 31 located on the downstream side changes its flow direction to the inner side of the vent passage 21, or diagonally downward to the rear side in this example, as it flows along the downstream fin 31. The air-conditioning air A1 is blown out from the outlet 16 diagonally downward to the rear side.

The air-conditioning air A1 flowing near the lower downstream fins 41 located on the upstream side changes its flow direction to the inner side of the vent passage 21, or diagonally upward to the rear side in this example, as it flows along the downstream fin 41. Part of the air-conditioning air A1 flowing along the downstream fin 41 impinges on the downstream fin 31 and flows along the downstream fin 31, thereby changing its flow direction diagonally downward to the rear.

As a result, the amount of the air-conditioning air A1 that flows along the downstream fin 31 and then blows out from the outlet 16 diagonally downward to the rear is increased by the air-conditioning air A1 whose flow direction is changed by the downstream fin 41.

The advantages of the present embodiment are now described.

(1) The present embodiment includes the actuation mechanism M1, which moves the downstream fins 31 and 41 between the neutral positions and the inclined positions. In the neutral position shown in FIG. 3, the actuation mechanism M1 causes the two downstream fins 31 and 41 to extend in the inflow direction and face each other in a direction orthogonal to the inflow direction.

This allows the air-conditioning air A1 to be blown out from the outlet 16 in the inflow direction. Also, the distance D1 between the downstream fins 31 and 41 is constant or substantially constant at any position in the inflow direction. This allows the distance D1 to be wider than the distance at the downstream ends of the fins of a conventional air-conditioning register, thereby reducing the ventilation resistance. This also limits the pressure loss when the downstream fins 31 and 41 are in the neutral positions, thereby improving the air conditioning performance.

(2) As shown in FIG. 5, in the neutral positions, the entire upper downstream fin 31 in the thickness direction is accommodated in the upper accommodation chamber 24. Also, the entire lower downstream fin 41 in the thickness direction is accommodated in the lower accommodation chamber 25.

This allows the sections of the downstream fins 31 and 41 that are located upstream of the outlet 16 to be smaller than in a configuration in which the entire downstream fins 31 and 41 are located upstream of the outlet 16. Accordingly, the downstream fins 31 and 41 are unlikely to reduce the actual opening area of the outlet 16. This further reduces the ventilation resistance caused by the downstream fins 31 and 41.

(3) In the present embodiment, either in the upward inclined positions shown in FIG. 9 or the downward inclined positions shown in FIG. 13, the two downstream fins 31 and 41 are moved to mutually different locations shifted upstream and downstream from the neutral positions. Additionally, the downstream fins 31 and 41 are inclined with respect to the inflow direction such that the downstream sides are located inward in the vent passage 21.

Thus, the downstream fin 31 (41) on the upstream side causes the air-conditioning air A1 to flow inward in the vent passage 21 and thus impinge on the downstream fin 41 (31) on the downstream side. Causing the air-conditioning air A1 to flow along the downstream fin 41 (31) on the downstream side increases the amount of the air-conditioning air A1 blowing out from the outlet 16 diagonally upward or downward to the rear side. This increases the directivity of the air-conditioning air A1 blown out from the outlet 16. The air conditioning performance is improved also in this respect.

(4) In the present embodiment, as described in (1) to (3) above, the upward and downward blow directions of the air-conditioning air A1 can be changed using only two downstream fins 31 and 41. This eliminates the need for an additional downstream fin placed upstream of the middle section in the vertical direction of the outlet 16 to achieve the same change of the blow direction.

As such, the degree to which the downstream fins 31 and 41 reduce the actual opening area of the outlet 16 is less than that in a configuration that includes an additional downstream fin provided upstream of the middle section in the vertical direction of the outlet 16. This limits an increase in the pressure loss, which would otherwise be caused by an additional downstream fin.

(5) As shown in FIG. 6, the present embodiment uses two types of shafts, the upstream shafts 35 and 45 and the downstream shafts 36 and 46, as the shafts of the downstream fins 31 and 41. As shown in FIGS. 4 and 10, as parts of the actuation mechanism M1, the upstream cam grooves 61 and 71, which engage with the upstream shafts 35 and 45, and downstream cam grooves 62 and 72, which engage with the downstream shafts 36 and 46, are provided.

Thus, determining the engagement positions of the downstream shafts 36 and 46 in the downstream cam grooves 62 and 72 determines the engagement positions of the upstream shafts 35 and 45 in the upstream cam grooves 61 and 71. The engagement positions determine the positions and inclinations of the downstream fins 31 and 41 accordingly.

Both downstream fins 31 and 41 are movable between the neutral positions and the inclined positions by rotating and moving the downstream shafts 36 and 46 in the downstream cam grooves 62 and 72 and by rotating and moving the upstream shafts 35 and 45 in the upstream cam grooves 61 and 71.

(6) As shown in FIGS. 4 and 10, in the present embodiment, the upstream cam grooves 61 and 71 extend linearly in the inflow direction. The upstream inclined portions 64 and 74 of the downstream cam grooves 62 and 72 are inclined with respect to the inflow direction such that the upstream sides are located inward in the vent passage 21. The downstream inclined portions 65 and 75 of the downstream cam grooves 62 and 72 are inclined with respect to the inflow direction such that the downstream sides are located inward in the vent passage 21.

Thus, as shown in FIGS. 3 and 4, when the downstream shafts 36 and 46 are placed in the middle portions 63 and 73 of the downstream cam grooves 62 and 72 by the actuation mechanism M1, the downstream fins 31 and 41 are placed in the neutral positions.

As shown in FIGS. 9 and 13, rotating and moving the downstream shaft 36, 46 in the upstream inclined portion 64, 74 causes the downstream fin 31, 41 to be inclined with respect to the inflow direction such that the downstream side is located inward in the vent passage 21 at a location shifted upstream from the neutral position.

Also, rotating and moving the downstream shaft 36, 46 in the downstream inclined portion 65, 75 causes the downstream fin 31, 41 to be inclined with respect to the inflow direction such that the downstream side is located inward in the vent passage 21 at a location shifted downstream from the neutral positions.

(7) As described in (4) above, the present embodiment does not include a downstream fin located upstream of the middle section in the vertical direction of the outlet 16.

Accordingly, as shown in FIG. 3, when the air-conditioning register 10 in which the downstream fins 31 and 41 are located in the neutral positions is viewed from the downstream side, the downstream fins are not visible in the middle section in the vertical direction of the outlet 16. As a result, the air-conditioning register 10 has an enhanced appearance.

(8) As described in (2) above, in the neutral position, the entire upper downstream fin 31 in the thickness direction is accommodated in the upper accommodation chamber 24. Also, the entire lower downstream fin 41 in the thickness direction is accommodated in the lower accommodation chamber 25.

As such, when the air-conditioning register 10 is viewed from the downstream side, the downstream fins 31 and 41 are not visible or unlikely to be visible. This further enhances the appearance of the air-conditioning register 10.

(9) As shown in FIGS. 5 and 6, in the present embodiment, the plate-shaped portion 32 of the upper downstream fin 31 includes the bulging portion 33, which bulges upward, at the downstream edge. The plate-shaped portion 42 of the lower downstream fin 41 includes the bulging portion 43, which bulges downward, at the downstream edge. These bulging portions 33 and 43 increase the rigidity of the plate-shaped portions 32 and 42, and thus the rigidity of the downstream fins 31 and 41.

In particular, in this embodiment, the bulging portions 33 and 43 of the downstream fins 31 and 41 extend over the entire lengths in the lateral direction of the plate-shaped portions 32 and 42. This allows the effect of increasing the rigidity described above to be achieved uniformly at any position in the lateral direction of the plate-shaped portions 32 and 42.

The bulging portions 33 and 43 bulge away from each other in the vertical direction. The bulging portions 33 and 43 do not bulge toward the space between the downstream fins 31 and 41. The bulging portions 33 and 43 are therefore unlikely to interfere with the air-conditioning air A1 flowing between the downstream fins 31 and 41.

(10) In the upward inclined position shown in FIG. 11, the lower downstream fin 41 located on the downstream side is inclined near the upstream side of the lower part of the outlet 16 such that the downstream side is higher. When the air-conditioning register 10 in this state is viewed from the downstream side, if the bulging portion 43 is not provided, the parts of the lower downstream fin 41 located on the lower surface of the plate-shaped portion 42, such as ribs, would be visible.

Also, in the downward inclined position shown in FIG. 13, the upper downstream fin 31 located on the downstream side is inclined near the upstream side of the upper part of the outlet 16 such that the downstream side is lower. When the air-conditioning register 10 in this state is viewed from the downstream side, if the bulging portion 33 is not provided, the parts of the upper downstream fin 31 located on the upper surface of the plate-shaped portion 32, such as ribs 34 (see FIGS. 6 and 7), would be visible. This may compromise the appearance of the air-conditioning register 10.

In this regard, as described in (9) above, the present embodiment includes the bulging portions 33 and 43, which bulge away from each other in the vertical direction, at the downstream edges of the plate-shaped portions 32 and 42. These bulging portions 33 and 43 hide the parts of the downstream fins 31 and 41 located upstream of the bulging portions 33 and 43. Accordingly, when the downstream fins 31 and 41 are located in the upward inclined position in FIG. 11 or in the downward inclined position in FIG. 13, the parts of the downstream fins 31 and 41 located upstream of the bulging portions 33 and 43 are less likely to be visible. This further improves the appearance of the air-conditioning register 10.

FIG. 1 shows a state in which, in the upward inclined position, the parts of the downstream fin 41 located upstream of the bulging portion 43 are hidden by the bulging portion 43.

The present embodiment may be modified as the following modifications. The above embodiment and the following modifications may be combined to an extent that does not cause technical contradiction.

### Modifications Related to Retainer 11

The outlet 16 may have a vertically elongated rectangular shape. In this case, the long side portions 18 of the outlet 16 extend in the vertical direction, and the short side portions 17 extend in the lateral direction.

The long side portions 18 and the short side portions 17 may be inclined with respect to a vertical plane.

The shape of the outlet 16 may be changed to a quadrangle shape other than a rectangular shape. The shape of the outlet 16 may also be changed to a polygon other than a quadrangle, an ellipse, or the like.

The retainer 11 may include only one of the outer and inner retainer members 12 and 13. Also, the retainer 11 may be formed by adding another member to the outer and inner retainer members 12 and 13.

The outlet 16 may be provided parallel to a vertical plane or may be provided in an inclined state.

### Modifications Related to Downstream Fins 31 and 41

In FIG. 3, when the upper downstream fin 31 is in the neutral position, only a part, such as an upper part, rather than the entirety in the thickness direction, of it may be accommodated in the upper accommodation chamber 24.

Also, when the upper downstream fin 41 is in the neutral position, only a part, such as a lower part, rather than the entirety in the thickness direction, of it may be accommodated in the lower accommodation chamber 25.

In this case, when the sections of the downstream fins 31 and 41 that are exposed from the accommodation chambers 24 and 25 to the inner side of the vent passage 21 are larger, the actual opening area of the outlet 16 is smaller.

The lengths in the direction along the short side portions 17 of the section of the downstream fin 31 extending downward from the upper accommodation chamber 24 and exposed, and the lengths of the section of the downstream fin 41 extending upward from the lower accommodation chamber 25 and exposed are referred to as the “lengths of exposed sections.”.

To limit the ventilation resistance and the pressure loss within permissible ranges, the lengths of the upper and lower exposed sections are preferably 2 mm or less when the length of the short side portion 17 is 15 mm to 23 mm.

In FIG. 6, at least either of the ribs 34 and the bulging portion 33 may be omitted from the upper downstream fin 31. The same applies to the lower downstream fin 41, and at least either of the ribs and bulging portion 43 may be omitted.

The positions of the upstream shaft 35 and the downstream shaft 36 in the lengthwise direction (lateral direction) of the plate-shaped portion 32 may be changed to positions other than the end portions. Likewise, the positions of the upstream shaft 45 and the downstream shaft 46 in the lengthwise direction (lateral direction) of the plate-shaped portion 42 may be changed to positions other than the end portions.

The positions of the upstream shaft 35 and the downstream shaft 36 of the downstream fin 31 in the flow direction may be changed to positions different from those in the above embodiment, provided that the positions are spaced apart from each other in the same direction. Likewise, the positions of the upstream shaft 45 and the downstream shaft 46 of the downstream fin 41 in the flow direction may be changed to positions different from those in the above embodiment, provided that the positions are spaced apart from each other in the same direction.

The upstream fin 47 may be omitted as appropriate.

In FIG. 6, the bulging portions 33 and 43 may be provided only partially in the lateral direction of the plate-shaped portions 32 and 42.

In FIG. 6, the bulging portions 33 and 43 may be arranged upstream of the downstream edges of the plate-shaped portions 32 and 42.

The plate-shaped portions 32 and 42 may be shaped to be inclined relative to the lateral wall portions 23 and extend in the inflow direction when the downstream fins 31 and 41 are in the neutral position.

The plate-shaped portions 32 and 42 of the downstream fins 31 and 41 may be shaped to curve upward or downward.

### Modifications Related to Operation Knob 51

In FIG. 1, the operation knob 51 may be provided at a location in the lateral direction different from the left end of the outlet 16, such as at the right end, or the middle.

In FIG. 1, the operation knob 51 may be placed at a position of the retainer 11 that is spaced apart from the outlet 16 in the lateral direction or in the vertical direction. Also, the operation knob 51 may be arranged outside the retainer 11. In this case, the operation knob 51 may be placed adjacent to the retainer 11 or may be placed away from the retainer 11. Furthermore, the operation knob 51 may be omitted.

In any of the above modifications, the effect of the operation knob 51 on the actual opening area of the outlet 16 can be reduced as compared with the above embodiment in which the operation knob 51 is disposed inside the outlet 16. This further reduces the pressure loss.

### Actuation Mechanism M1

The actuation mechanism M1 may move the downstream fins 31 and 41 by transmitting the movement of the operation knob 51 to the upstream shafts 35 and 45 instead of the downstream shafts 36 and 46.

The shapes of the upstream cam grooves 61 and 71 may be changed to a shape different from that of the above embodiment, provided that Conditions 2 and 3 below are satisfied. Similarly, the shape of the downstream cam grooves 62 and 72 may be changed to a shape different from that of the above embodiment.

Condition 2: In the neutral positions, the downstream fins 31 and 41 extend in the inflow direction and face each other in a direction orthogonal to the inflow direction.

Condition 3: In the inclined positions, the two downstream fins 31 and 41 are moved to mutually different locations shifted upstream and downstream from the neutral positions and inclined with respect to the inflow direction such that the downstream sides are located inward in the vent passage 21.

An actuation mechanism that moves the upper downstream fin 31 between the neutral position and the inclined position and an actuation mechanism that moves the downstream fin 41 between the neutral position and the inclined position may be provided separately.

### Modifications Related to Application Locations

The air-conditioning register 10 is also applicable to an air-conditioning register installed in a location other than the instrument panel in the passenger compartment, such as the dashboard.

The above air-conditioning register 10 has a wide range of applications in addition to vehicles, as long as it can change, at least with the downstream fins 31 and 41, the direction of the air-conditioning air A1 sent from the air conditioner and blown out into a compartment.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An air-conditioning register comprising:
a retainer defining a vent passage including an outlet at a downstream end in a flow direction of air-conditioning air;
two fins disposed upstream of the outlet in the vent passage; and
an actuation mechanism, wherein
the flow direction that is changed by the fins includes an inflow direction, the inflow direction being the flow direction of the air-conditioning air immediately before entering between the fins,
positions of the fins that cause the air-conditioning air to be blown out from the outlet in the inflow direction are defined as neutral positions,
positions of the fins that cause the air-conditioning air to be blown out from the outlet in a direction inclined with respect to the inflow direction are defined as inclined positions,
the actuation mechanism is configured to move the fins between the neutral positions and the inclined positions,
when the fins are in the in the neutral positions, the actuation mechanism causes the fins to extend in the inflow direction and face each other in a direction orthogonal to the inflow direction, and
when the fins are in the inclined positions, the actuation mechanism moves the fins to separate locations respectively located upstream and downstream from the neutral positions, and tilts the fins with respect to the inflow direction such that downstream sides of the fins are located inward in the vent passage.

2. The air-conditioning register according to claim 1, wherein
each fin includes:
a plate-shaped portion extending in a lengthwise direction;
an upstream shaft extending from the plate-shaped portion in the lengthwise direction; and
a downstream shaft extending from the plate-shaped portion in the lengthwise direction at a position downstream of the upstream shaft,
the actuation mechanism includes:
an upstream cam groove with which the upstream shaft is engaged in a rotatable and movable manner; and
a downstream cam groove with which the downstream shaft is engaged in a rotatable and movable manner, and
the fins are moved between the neutral positions and the inclined positions when the actuation mechanism changes a position of the upstream shaft in the upstream cam groove and changes a position of the downstream shaft in the downstream cam groove.

3. The air-conditioning register according to claim 2, wherein
the upstream cam groove extends in the inflow direction,
the downstream cam groove includes a section that is upstream of a middle portion in the inflow direction and inclined such that an upstream side is located inward in the vent passage,
the downstream cam groove includes a section that is downstream of the middle portion in the inflow direction and inclined such that a downstream side is located inward in the vent passage, and
when in the neutral position, the downstream shaft is placed in the middle portion of the downstream cam groove by the actuation mechanism.

4. The air-conditioning register according to claim 1, wherein
each fin includes a plate-shaped portion extending in the lengthwise direction,
the outlet includes two side portions that extend in the lengthwise direction and face each other,
accommodation chambers are disposed upstream of the outlet of the retainer and at separate outer sides of the outlet in a direction in which the side portions face each other, and
when the fins are in the neutral positions, at least a part of each fin in a thickness direction of the plate-shaped portion of the fin is accommodated in the corresponding accommodation chamber.

5. The air-conditioning register according to claim 3, wherein
the actuation mechanism further includes a link member rotationally supported by a support shaft portion extending in the lengthwise direction, and
the link member is coupled to the downstream shaft of one of the fins and the downstream shaft of the other fin in a manner that enables power transmission.
